(19) United States
(12) Patent Application Publication
(10) Pub. No.: US 2012/0025685 A1
(43) Pub. Date: Feb. 2, 2012

(54) Self-Closing Barrier Screen

(75) Inventors: Simon Clegg, Northampton (GB); Kirin Kopalan, Northampton (GB)

(73) Assignee: ROLLATHERM DESIGNS LIMITED, London (UK)

(21) Appl. No.: 13/145,833

(22) PCT Filed: Jan. 22, 2010
(86) PCT No.: PCT/GB2010/000098

§ 371 Date: Oct. 4, 2011

(30) Foreign Application Priority Data
Jan. 23, 2009 (GB) 09011529
May 11, 2009 (GB) 09080326

(51) Int. Cl. A47F 3/04; E06B 9/17; E06B 9/62

(52) U.S. Cl. 312/400; 160/309; 160/1; 312/297

(57) ABSTRACT

There is described a horizontally slidable self-closing screen assembly which comprises at least one screen material connected to a roller biasing the screen to an open position, the roller being operably connected to a counterweight and wherein the load provided by the weight is greater than the force provided by the roller biasing the screen. There are also described a housing unit containing the slidable screen assembly and a cabinet fitted with such a housing unit.

### FIELD OF THE INVENTION

The present invention relates to a novel form of roller blind, new apparatus and methods related thereto.

More particularly the present invention relates to a novel roller blind and a novel roller blind system for use, for example, in connection with display cabinets, such as chiller or refrigerator cabinets, tobacco cabinets or drink cabinets and similar such cabinets wherein there is a desires to screen the produce from the consumer at a chosen time.

### BACKGROUND OF THE INVENTION

There are numerous reasons why it may be desirable to screen merchandise or produce, i.e. goods on display in a retail environment, especially if the goods are of the sort that are required to be stored in a refrigerator or chiller cabinet. For example, due to increasing restrictions on carbon emissions and carbon footprints the requirement to provide thermal screens for refrigerators and chiller cabinets has increased. Currently, in the UK alone, tens of thousands of supermarket freezer cabinets are open, i.e. without doors or any other form of screen. This creates a huge energy waste and the cost is often passed on to consumers, for example, in the form of higher food prices. Increasingly, supermarkets are being encouraged to put doors on all freezer units and chiller cabinets so as to reduce energy waste.

Optimum operating temperature for a chiller cabinet is from about 2 to 4° C., less for a freezer cabinet. Many different methods of screening chilled or frozen produce have been developed. For refrigerated retail displays it is desirable to provide a screen that can be operated by the customer, for example, in shopping stores, supermarkets and the like, without creating an obstruction when the doors of such cabinets are opened. Thus, screens may be seen as an obstruction to the consumer. However, in order to minimise any obstruction to the consumer and maximise thermal and/or energy efficiency, it is desirable to provide a self-closing screen for, e.g. a chiller cabinet.

Glass doors, and especially double glazed glass doors are often used, especially for chiller cabinets or freezer units that have a “vertical” display of the produce. Although sliding doors have been developed to try to minimise the obstruction that may be created when such doors are opened. However, all glass doors suffer from the disadvantage that a cold air barrier is created directly on the inside of the glass panel. This can lead to excessive condensation thus restricting visibility and deterring the customer from purchasing the produce. Sliding doors are beneficial in that the cause less of an obstruction than conventionally hinged doors, but they are particularly susceptible to being inadvertently left open by the consumer.

In addition, such glass doors are disadvantageous in that they are expensive to manufacture and install and they are heavy, thus being problematical to install and use.

European Patent Application No. 1 158 135 describes a horizontally sliding screen for, e.g. French doors, comprising a roll-back mechanism provided with a spring and a weight wherein the load of the weight is less than or equal than the force of the spring. Such an arrangement is not suitable for use in connection with a chiller or freezer cabinet, since, inter alia, it does not act as a self closing barrier or screen, and in fact arranged to be urged to an open position.

### SUMMARY OF THE INVENTION

Thus, there is a need for a lightweight and inexpensive self-closing cabinet screen, e.g. chiller cabinet screen. Therefore, according to a first aspect of the invention we provide a horizontally slidable self-closing screen assembly which comprises at least one screen material connected to a roller biasing the screen to an open position, the roller being operably connected to a counterweight and wherein the load provided by the weight is greater than the force provided by the roller biasing the screen.

Biasing means for the roller may comprise conventional means used in a roller blind. Thus, the biasing means may be, for example, a spring biasing means optionally inside the roller, such as a torsion spring.

The assembly according to the invention preferentially operates by being opened manually and upon release, the screen will close. Therefore, as hereinbefore described, the load provided by the counterweight should be greater than the load provided by the spring biasing the roller. The difference between the load provided by the spring and the load provided by the counterweight may vary and may influence the speed and or strength at which the screen closes. Thus, for example, the counterweight may have a load which is from 5 to 50% greater than the spring load, or from 10 to 30% greater than the springload, or from 20% to 30% greater than the spring load, e.g. 25% greater than the spring load. Thus, by way of example only, the assembly may be provided with a spring which has a load of about 1.2 kg. It will be understood that the counterweight must be greater than the spring load, however, if the counterweight is too light, compared to the spring load, then the screen may close too slowly. Similarly, if the counterweight is too heavy then the screen may close too quickly and may have the potential to cause injury. Thus, for a spring load of 1.2 kg the counterweight should be from about 1.3 kg to about 1.7 kg, preferably from about 1.4 kg to about 1.6 kg, more preferably from about 1.45 kg to about 1.55 kg and most preferably about 1.5 kg. Therefore, according to a further aspect of the invention we provide a horizontally slidable self-closing screen assembly as hereinbefore described wherein the spring has a load of 1.2 kg and the counterweight has a load of from about 1.3 kg to about 1.7 kg. Thus, the ratio of the load of the spring versus the load of the counterweight may be from 1:1.08 to 1.42, preferably from about 1:1.17 to about 1.33, more preferably from about 1:1.21 to about 1:1.29 and most preferably about 1:1.36.

Thus, the screen which, in use, may be horizontally mounted, will comprise a first end which is openable and which travels when the screen is opened and closed. This first end is distal to the torsioned spring roller assembly unit. The second end of the screen is connected to the torsioned spring roller assembly unit and thus when the screen is opened this end is wrapped around the roller. Thus, the counterweight is preferentially operably linked to the distal first end of the screen and therefore when a user opens the screen, the screen is urged to wrap around the roller and the counterweight will be raised. When the user releases the screen the operation of gravity on the counterweight and the greater load provided by the counterweight, when compared to the torsion spring of the roller counterweight, urges the screen to close. Therefore, it is desirable that the distal end of the screen is operably linked to the counterweight.

In a particular aspect of the present invention, the distal end of the screen is operably linked to the counterweight via a cable, cord or wire, etc. The cable is preferentially connected between the screen and the counterweight via a pulley.

In an especially preferred aspect of the invention the screen is provided with a pair of connections to the counterweight. For example, when the screen is mounted horizontally the first end of the screen may be operably connected to the counterweight as hereinbefore described adjacent to its upper end and adjacent its lower end. This pair of connections is advantageous in that it enables the screen to open, and especially to close, more smoothly. The use of a pair of screens as described herein is advantageous in that, inter alia, it provides convenient access for the consumer to the merchandise. Moreover, whilst the present invention dos envisage the use of a single self-closing barrier screen, a single screen necessarily increases the profile diameter of the roller when the screen is in the open position and thereby the frame housing the assembly must be larger to accommodate this. This consequently reduces the effective selling space for the merchandise which is undesirable for the retailer or merchandise manufacturer. Also, if a single screen is not fully retracted areas of the merchandise display unit may be less accessible. Thus, the use of a double screen assembly as hereinbefore described maximises the visibility and accessibility of the merchandise.

For use with a chiller cabinet or freezer cabinet the screen may comprise a thermal insulation barrier. Thus, for example, the screen may comprise a thermally insulating fabric or film. An example of such a thermally insulating film may be a film comprising a polymer or co-polymer. Although a variety of polymers or co-polymers conventionally known in the art may be used, examples of such polymer may be polyvinyl acetate (PVA) or polyvinyl chloride (PVC) and the like.

It is also desirable that the screen may comprise a substantially transparent material. This is especially preferred if the screen is fitted to a display cabinet, such as a freezer or chiller cabinet. Polymer films as hereinbefore described, such as PVA or PVC films, are suitably available as transparent films which may be used in the assembly of the present invention.

Furthermore, for use in freezer or chiller cabinets the screen may comprise a perforated material. The use of a perforated material is advantageous in that, inter alia, the perforations may prevent condensation from forming and thus enable the screen to maintain its transparency and provide good visibility, enabling customers to view the products on display in the cabinet.

The assembly as hereinbefore described may be placed in a housing unit. Thus, the housing unit may comprise a facia that is mountable on existing display or chiller cabinets. The use of such a housing unit allows the screen assembly of the invention to be easily fitted in situ. A further advantage as hereinbefore described is that the housing for use in connection with a pair of screens may be peripherally smaller than a hosing used with a conventional roller blind assembly, thus increasing merchandise visibility and accessibility.

The assembly may desirably be arranged so that a cover of the assembly may be easily removed. This is especially beneficial for use where a chiller cabinet houses fresh produce as it facilitates ease of access for cleaning, etc.

Therefore, according to a further aspect of the invention we provide a housing unit adapted to contain or containing a slidable self-closing screen assembly which comprises at least one screen material connected to a roller biasing the screen to an open position, the roller being operably connected to a counterweight and wherein the load provided by the weight is greater than the force provided by the roller biasing the screen.

The housing unit may be provided with one or more channels in which the one or more pulleys may sit. Thus, when the screen is opened or closed and the one or more pulleys linked to the first end of the screen travel with the screen, the one or more pulleys are provided with a smooth travelling surface. Preferably, each travelling pulley is provided with its own channel.

It will be understood by the person skilled in the art that the unit may operate satisfactorily with a single slidable screen. However, it is desirable that the unit is provided with a pair of screens each of which is slidable. Each of the screens may be independently slidable or may be operably linked to each other so that when a user slides one screen both screens slide open and/or closed.

In a yet further aspect of the invention we provide a cabinet, such a chiller cabinet, display cabinet, etc. fitted with a screen assembly and/or a housing unit as hereinbefore described.

In a further aspect of the invention the screen assembly or the unit may be fitted with one or more sensors, which might be beneficial as an additional safety measure, alternatively or in addition, if a sensor is e.g. a motion sensor, it may enable the opening and/or closing of the screen to be automated. Such an arrangement may be especially advantageous for marketing merchandise to certain customer or for customers that are infirm or are not able bodied. Thus, for example, automatic opening and/or closing sensor may be operate a microwave Doppler action or may comprise active or passive infrared detection which detects the motion of a person approaching the cabinet or screen. Such sensors may be used to detect movement of a person approaching the screen and thus the screen may be automated and set to open when a person is in the vicinity.

When the assembly is automated as hereinbefore described, the screen may, for example, be connected to one or more motors. The assembly may use conventionally known motors which may be mechanical, pneumatic, electrical or kinetic in nature. Alternatively, the automated assembly may use one or more actuators. The one or more actuators according to this aspect of the invention may be pneumatic or electrical actuators. If more than one actuator or motor is present they may be the same or different. When the assembly of the invention is automated, the assembly may include a counterweight as hereinbefore described or may the assembly may rely solely on the use of the one or more motors. It will be understood by the person skilled in the art that when the assembly includes a motor, this may optionally be with or without the use of a sensor.

Furthermore, the assembly may be maintained in the open position by the use of one or more magnets, for example, electro magnets. The one or more magnets according to this aspect of the invention may optionally be part of a timed relay that is adjustable so that the amount of time the assembly is held in the open position can be a manufacturers fixed setting or may be adjusted, e.g. manually, to suit user requirements. When the assembly comprises a manually adjustable magnetic system as hereinbefore described, this system may also incorporate a manual override capable of being operated to keep the doors open for unlimited periods to allow access for longer periods of time. Such a system is advantageous, inter alia, it allows the screen to be maintained in the open position to permit the stocking of shelves, maintenance, etc.

The unit as hereinbefore described may be provided pre-assembled. Alternatively, the unit may be provided in kit form. Therefore, according to a yet further aspect of the invention we provide a kit comprising, in a first part, at least one screen material; in a second part, a roller assembly including a torsion spring, a counterweight and pulley system and wherein the load provided by the weight is greater than the force provided by the roller biasing the screen; and optionally in a third part a housing unit adapted to contain a slidable screen assembly.

According to a yet further aspect of the invention we provide a method of screening a cabinet which comprises fitting to a cabinet at least one screen material connected to a roller biasing the screen to an open position, the roller being operably connected to a counterweight and wherein the load provided by the weight is greater than the force provided by the roller biasing the screen.

Preferably in this aspect of the invention the method comprises fitting to a cabinet a screen assembly in a housing unit as hereinbefore described.

The assembly of the present invention, unit or kit of the present invention is advantageous in that, inter alia, it proposes a frame that incorporates two vertically positioned self-retracting blinds. This will then create a self closing barrier screen that can be fitted to the front of a cabinet. When fitted the self closing barrier screen will be in the closed position. This means that the two screens (left & right) will meet in the centre, thus creating a thermal barrier, keeping the cold air in and the warm air out. The fabric will be of a transparent nature with a special perforation. The perforation will prevent condensation from forming and thus provide good visibility and enable the customer to view the product on the shelf. To open the self closing barrier screen, the customer pushes aside the relative left or right side screen to access the product. The relative left or right screen will then close automatically to centre slowly.

This invention will not be restricted to use on refrigerators only. Thus, for example, the screen assembly of the invention may be utilised as a thermal screen for any thermally insulated cabinet, such as a chilled cabinet, a refrigerator or freezer or the like or a cabinet which displays warmed, e.g. ready to eat, food. Furthermore, with the use of different fabrics and incorporating locking systems in the shutter beams, the screen assembly can be used as a Secure-Self Closing Barrier Screen. This can be used in conjunction with many applications where a Self-Closing Barrier Screen is required, e.g. cabinets, doorways, shelving and windows etc, etc. For example, the assembly may be used in conjunction with a tear or slash resistant fabric or other material in a secure cabinet for the storage and/or display of restricted products, such as cigarettes or other tobacco products or high value products.

The invention will now be described solely by way of example and with reference to the accompanying drawings in which:

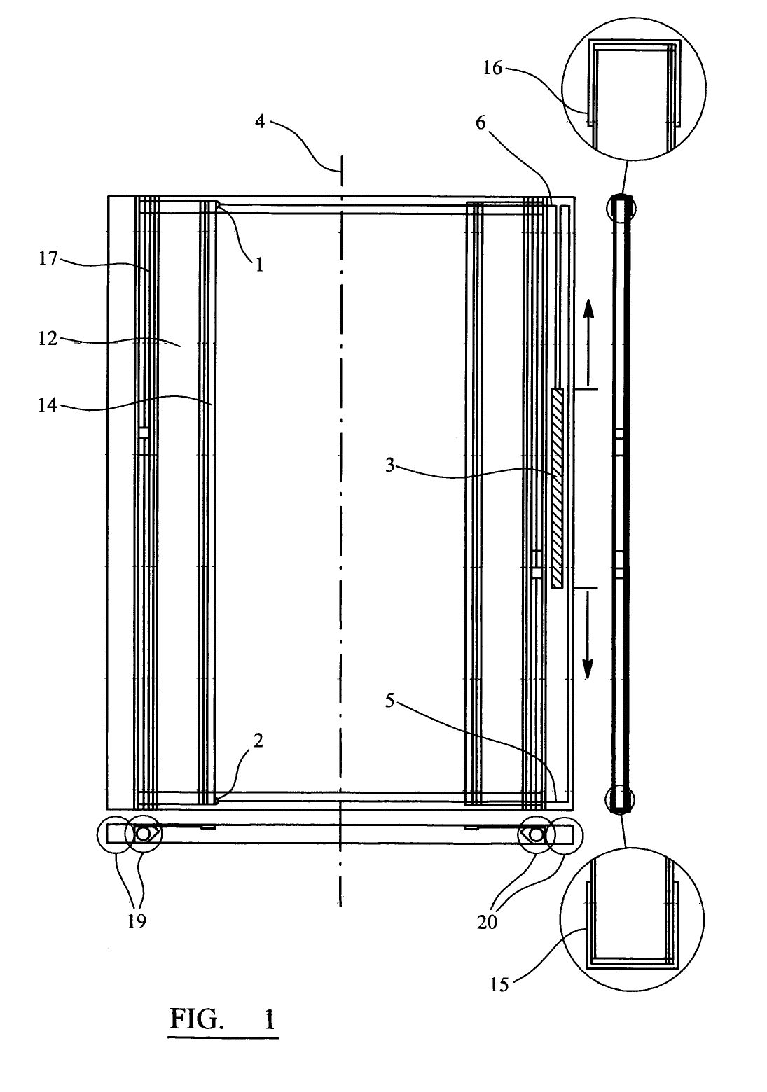

FIG. 1 illustrates the function of a Left hand side screen; and

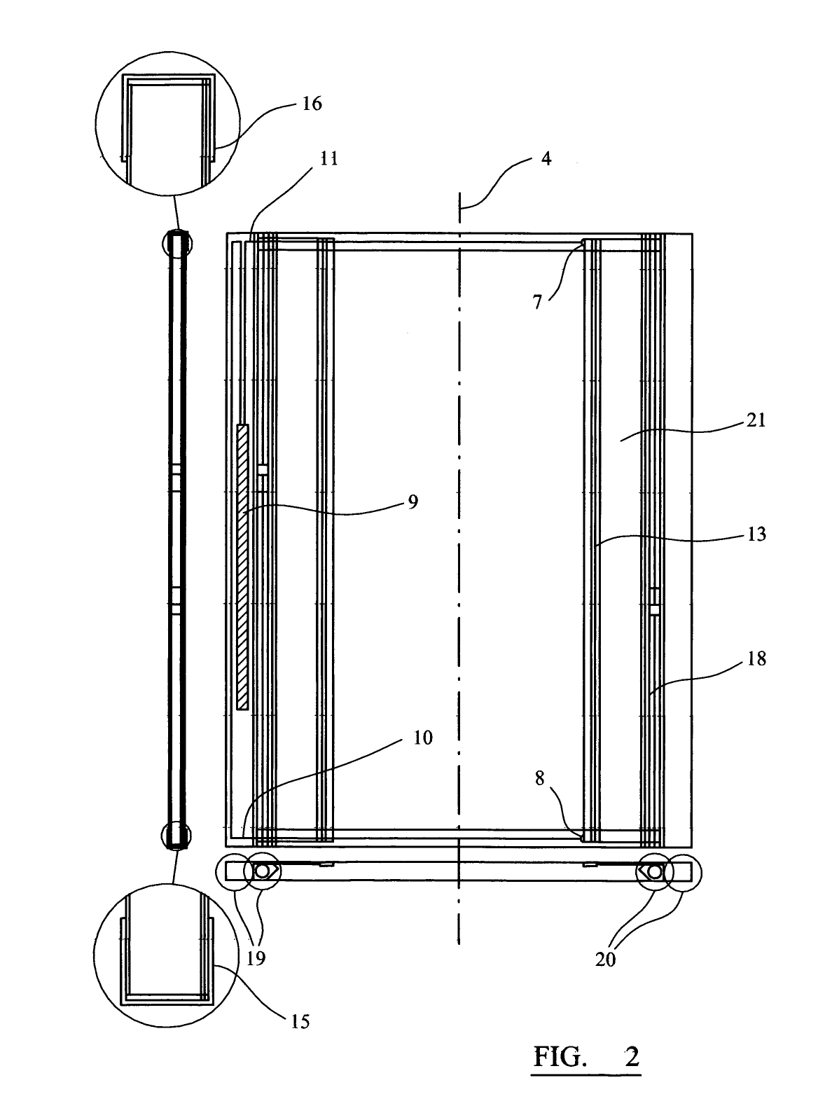

FIG. 2 illustrates the function of a Right hand side screen.

Referring to FIG. 1, the left hand side screen function is described. Enclosed within the roller blind unit (19), is a charged torsion spring assembly (17). This charged spring assembly (17), is responsible for retracting the fabric (12), evenly into the roller blind unit (19). At the top of the vertical beam (14), there is a pulley cable to vertical beam connection point (1), for which a pulley cable (6) connects. The pulley cable (6) is then routed through the frame and connects to the weight (3). The weight (3), acts as a constant load. This load is constantly pulling the vertical beam (14), and therefore keeping it in the close position at the centre line (4), by means of a stop. When the vertical beam (14), is pushed away from the centre position (4), the weight (3), slides freely upwards within the roller blind unit (20). When the vertical beam (14), is released the constant load by means of the weight (3), pulls it to the closed position at the centre line (4).

To enable the vertical beam (14), to have a smooth and even action at the bottom of the vertical beam (14), there is another pulley cable to vertical beam connection point (2), for which another pulley cable (5) connects. The pulley cable (5) is then routed through the frame and connects to the weight (3). The weight (3,) acts as a constant load. This load is constantly pulling the vertical beam (14), and therefore keeping it in the close position at the centre line (4), by means of a stop. When the vertical beam (14), is pushed away from the centre position (4), the weight (3), slides freely upwards within the roller blind unit (20). When the vertical beam (14), is released the constant load by means of the weight (3), pulls it to the closed position at the centre line (4).

In FIG. 2, the right hand side screen function is described. Enclosed within the roller blind unit (20), is a charged torsion spring assembly (18). This charged spring assembly (18), is responsible for retracting the fabric (21), evenly into the roller blind unit (20). At the top of the vertical beam (13), there is a pulley cable to vertical beam connection point (7), for which a pulley cable (11) connects. The pulley cable (11) is then routed through the frame and connects to the weight (9). The weight (9), acts as a constant load. This load is constantly pulling the vertical beam (13), and therefore keeping it in the close position at the centre line (4), by means of a stop. When the vertical beam (13), is pushed away from the centre position (4), the weight (9), slides freely upwards within the roller blind unit (19). When the vertical beam (13), is released the constant load by means of the weight (9), pulls it to the closed position at the centre line (4).

To enable the vertical beam (13), to have a smooth and even action at the bottom of the vertical beam (13), there is another pulley cable to vertical beam connection point (8), for which another pulley cable (10), connects. The pulley cable (10) is then routed through the frame and connects to the weight (9). The weight (9), acts as a constant load. This load is constantly pulling the vertical beam (13), and therefore keeping it in the close position at the centre line (4), by means of a stop. When the vertical beam (13), is pushed away from the centre position (4), the weight (9), slides freely upwards within the roller blind unit (19). When the vertical beam (13), is released the constant load by means of the weight (9), pulls it to the closed position at the centre line (4).

1. A horizontally slidable self-closing screen assembly which comprises at least one screen material connected to a roller biasing the screen to an open position, the roller being operably connected to a counterweight and wherein the load provided by the weight is greater than the force provided by the roller biasing the screen.

2. A horizontally slidable self-closing screen assembly according to claim 1 wherein the roller is biased by a spring biasing means

3. A horizontally slidable self-closing screen assembly according to claim 2 wherein the spring biasing means is a torsion spring, optionally inside the roller.

4. A horizontally slidable self-closing screen assembly according to claim 2 wherein the load provided by the counterweight should be greater than the load provided by the spring biased roller.

5. A horizontally slidable self-closing screen assembly according to claim 4 wherein the counterweight has a load which is from 5 to 50% greater than the spring load.

6. (canceled)

7. A horizontally slidable self-closing screen assembly according to claim 4 wherein the ratio of the load of the spring versus the load of the counterweight may be from 1:1.08 to 1.42.

8. A horizontally slidable self-closing screen assembly according to claim 1 wherein the screen comprises a first end which is openable and which travels when the screen is opened and closed and the counterweight is operably linked to the first end of the screen.

9.-10. (canceled)

11. A horizontally slidable self-closing screen assembly according to claim 1 wherein the screen is provided with a pair of connections to the counterweight.

12.-14. (canceled)

15. A horizontally slidable self-closing screen assembly according to claim 1 wherein the assembly comprises a pair of screens.

16. A horizontally slidable self-closing screen assembly according to claim 1 wherein the screen comprises a thermal insulation barrier.

17. A horizontally slidable self-closing screen assembly according to claim 1 wherein the screen comprises a transparent material.

18. A horizontally slidable self-closing screen assembly according to claim 1 wherein the screen comprises a perforated material.

19. A housing unit adapted to contain or containing a slidable self-closing screen assembly which comprises at least one screen material connected to a roller biasing the screen to an open position, the roller being operably connected to a counterweight and wherein the load provided by the weight is greater than the force provided by the roller biasing the screen.

20.-23. (canceled)

24. A housing unit according to claim 19 wherein the unit is fitted with one or more sensors, enabling to the opening and/or closing of the screen to be automated.

25.-29. (canceled)

30. A housing unit according to claim 19 which is adapted to be maintained in the open position by the use of one or more magnets.

31. (canceled)

32. A housing unit according to claim 30 wherein the one or more magnets are part of a timed relay that is adjustable so that the amount of time the assembly is held in the open position.

33. (canceled)

34. A cabinet fitted with a housing unit wherein the housing unit is adapted to contain or containing a slidable self-closing screen assembly which comprises at least one screen material connected to a roller biasing the screen to an open position, the roller being operably connected to a counterweight and wherein the load provided by the weight is greater than the force provided by the roller biasing the screen.

35. A cabinet according to claim 34 wherein the cabinet is a thermally insulated cabinet.

36. A cabinet according to claim 34 wherein the cabinet is a secure cabinet.

37. A kit comprising, in a first part, at least one screen material; in a second part, a roller assembly including a torsion spring, a counterweight and pulley system and wherein the load provided by the weight is greater than the force provided by the roller biasing the screen; and optionally in a third part a housing unit adapted to contain a self-closing slidable screen assembly.

38.-40. (canceled)
